(19) United States
(12) Patent Application Publication
(10) Pub. No.: US 2007/0081652 A1
(43) Pub. Date: Apr. 12, 2007

(54) Method and system for identification of importance of communications

(76) Inventors: Juan C. Fernandez, Boca Raton, FL (US); Jorge L. Perdomo, Boca Raton, FL (US); Lisajane Meyers Romer, Boca Raton, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/238,255

(22) Filed: Sep. 29, 2005

(51) Int. Cl. H04M 3/42

(52) U.S. Cl. 379/208.01

(57) ABSTRACT

The invention concerns a communication device (100) and method (300) for identification of the importance of a communication. As an example, the method can include the steps of assigning (312) a level of importance to a communication on a communication device (100) and in response to assigning the level of importance, providing (320) a machine-based indication that corresponds to the level of importance that enables a potential interrupter of the communication to determine whether to interrupt the communication. As an example, the method can include the step of executing (324) visual or audible alerts at the communication device or at a remote unit (200) that is in communication with the communication device.

### BACKGROUND OF THE INVENTION

1. Field of the Invention

This invention relates in general to the management of communications, such as phone calls, and more particularly, to providing an indication as to the nature of such communications.

2. Description of the Related Art

The use of portable electronic devices has risen in recent years. Cellular telephones and other communication devices, in particular, have become very popular with the public. Because of their proliferation, a greater number of individuals are using such devices, which leads more calls being made. In view of a greater number of calls being made, especially in virtually any setting, the chances that an individual may need to interrupt a person using a communication device has increased. Unfortunately, there is no way for the individual who must interrupt the person using the device to know whether the person wishes to be bothered during the communication.

### SUMMARY OF THE INVENTION

The present invention concerns a method for identification of the importance of a communication. The method can include the steps of assigning a level of importance to a communication on a communication device and in response to assigning the level of importance, providing a machine-based indication that corresponds to the level of importance. The indication can enable a potential interrupter of the communication to determine whether to interrupt the communication.

In one arrangement, assigning the level of importance can include assigning importance tags to communication identifiers associated with contacts and assigning the level of importance either prior to the start of or during the communication on the communication device. In another arrangement, the method can include the step of measuring biometric characteristics of a speaker during the communication, and assigning the level of importance can be based on the measured characteristics.

In one embodiment of the invention, providing a machine-based indication can include providing a visual alert, an audible alert or both. In addition, providing a machine-based indication can include executing the visual and audible alerts at the communication device or at a remote unit that can be in communication with the communication device. The method can also include the step of wirelessly transmitting a signal from the communication device over a communications network to provide the machine-based indication at the remote unit. As an example, the remote unit can be a telephone, a personal digital assistant, a computer or a display.

The method can also include the step of altering one or more settings on the communication device based on the level of importance assigned to the communication. As another example, the visual alert can be from a light source illuminated in one of a plurality of colors that correspond to different levels of importance.

The present invention also concerns a communication device that identifies the importance of a communication. The communication device can include a transceiver that can receive and transmit communication signals and a processor coupled to the transceiver. The processor scan be programmed to assign a level of importance to a communication on a communication device and in response to assigning the level of importance, to generate a machine-based indication signal that can correspond to the level of importance. The indication signal can enable a potential interrupter of the communication to determine whether to interrupt the communication. The communication device can also include suitable software and circuitry to enable it to perform any of the above-described processes.

The present invention also concerns a machine readable storage, having stored thereon a computer program having a plurality of code sections executable by a computing device. The computer program can cause the computing device to perform the steps of assigning a level of importance to a communication on a communication device and in response to assigning the level of importance, providing a machine-based indication that can correspond to the level of importance. The indication can enable a potential interrupter of the communication to determine whether to interrupt the communication. The computer program can also include code sections that can cause the computing device to perform any of the above-described processes.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 illustrates a communication device that can identify the importance of a communication device in accordance with an embodiment of the inventive arrangements;

FIG. 2 illustrates the communication device and several remote units that can communicate with the communication device in accordance with an embodiment of the inventive arrangements; and

FIG. 3 illustrates a method for the identification of the importance of a communication in accordance with an embodiment of the inventive arrangements.

### DETAILED DESCRIPTION OF THE INVENTION

While the specification concludes with claims defining the features of the invention that are regarded as novel, it is believed that the invention will be better understood from a consideration of the following description in conjunction with the drawings, in which like reference numerals are carried forward.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “suppressing” can be defined as reducing or removing, either partially or completely.

The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

The present invention concerns a method and communication device for identification of the importance of a communication. In one arrangement, the method can include the steps of assigning a level of importance to a communication on a communication device and in response to assigning the level of importance, providing a machine-based indication that can correspond to the level of importance. This machine-based indication can enable a potential interrupter of the communication to determine whether to interrupt the communication. As an example, the step of providing a machine-based indication can include providing a visual alert, an audible alert or both. The visual or audible alerts can be executed at the communication device or at a remote unit that is in communication with the communication device.

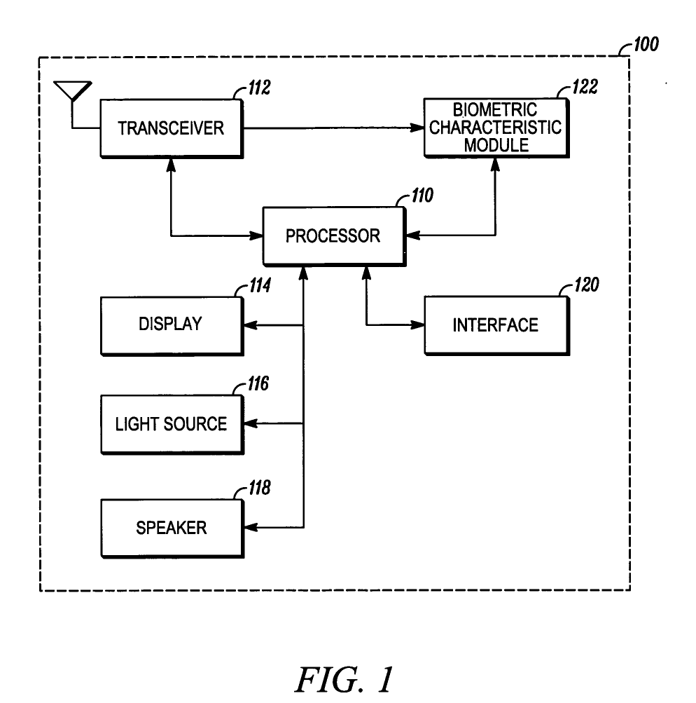

Referring to FIG. 1, a communication device 100 that can identify the importance of a communication is shown. A communication can be any transfer of information, including but not limited to speech and data, to the communication device and can include both ingoing and outgoing communications. The communication device 100 can be any device capable of allowing a user to communicate with any other suitable entity. As an example, the communication device 100 can be a telephone (wired or wireless), a personal digital assistant (PDA) or a computer. In one embodiment, the communication device 100 can include a processor 110, a transceiver 112, a display 114, a light source 116 and a speaker 118. The device 100 may also include an interface 120 for interfacing with one or more other components through a hard-wired connection. As another option, the device 100 may include a biometric characteristic module 122. As an example, the processor 110 can be coupled to and control the operation of each of the components listed above. The processor 110 may also be more than one discrete processor.

The transceiver 112 can transmit and receive wireless signals, as is known in the art. Although shown in FIG. 1 as a single unit, the transceiver 112 may include one or more discrete receiver components and one or more discrete transmitter components. In addition, the transceiver 112 is capable of transmitting any suitable type of wireless communications, including—but not limited to—those for wide area networks (WAN) (both interconnect and dispatch), wireless local area networks (WLAN), Bluetooth or near field communications (NFC). The device 100 can include any suitable number of transceivers 112 for operation in the above-listed (or any other) communication protocols or standards. The communication device 100 may also communicate with other devices with or without the assistance of a network.

The light source 116 can be any light source capable of emitting any color of light. For example, the light source 116 can be any number of light emitting diodes (LED), which may be suitably positioned on the outside of the communication device 100. In one arrangement, the biometric characteristic module 122 can measure a user's or caller's biometric characteristics. As an example, the biometric characteristic module 122 can measure the characteristics of a speaker's voice, such as the amount of anxiety or angst in that person's speech. This type of measurement is well known in the art, and any suitable technique may be employed here. Of course, the biometric characteristic module 122 can measure any other suitable biometric characteristic. Additionally, the biometric characteristic module 122 can include any suitable combination of hardware and software to perform this function and may even be considered part of the processor 110, as well.

As is known in the art, the display 114 can display various types of information. As an example, the communication device 100 may be a wireless telephone, and a user may generate one or more menu entries. As an example, a user may create a contact list that includes contact information for various entities, like special persons or business phone numbers. Those of skill in the art will appreciate that such a contact list may include phone numbers, e-mail addresses, physical addresses or any other suitable type of information that can allow the user to engage the contact. Of course, the invention is not limited to any of these particular examples.

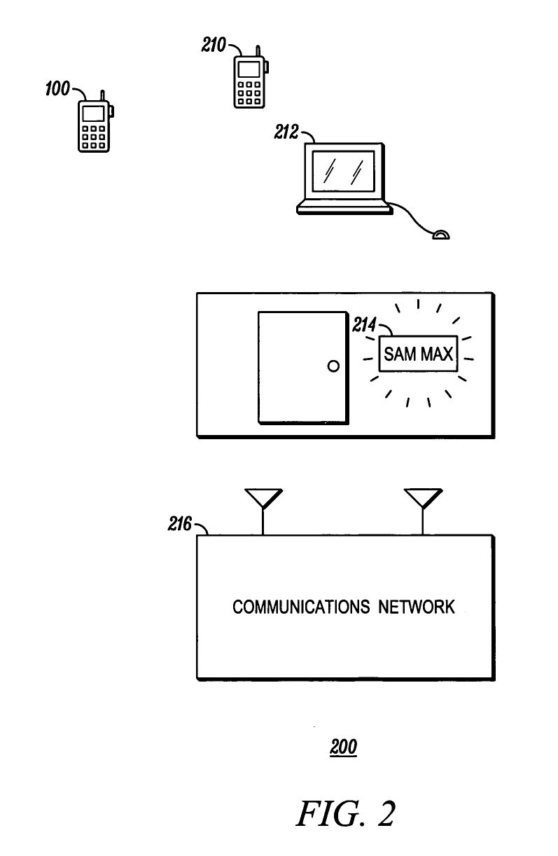

Referring to FIG. 2, the communication device 100 can communicate with any one of numerous remote units 200. A remote unit can be any unit that has the capability of receiving wireless or wired signals from the communication device 100. The device 100 can communicate with the remote units 200 through wired connections via the interface 120 (see FIG. 1) or through a wireless connection via the transceiver 112 (see also FIG. 1). There is no limit to the type of remote unit 200 with which the device 100 can communicate, although FIG. 2 shows several examples, including a wireless telephone or PDA 210, a computer 212, a display 214 and a communications network 216. The communications network 216 can be, for example, a WAN or a WLAN. As another example, the communication network 216 can be an NFC system or any other suitable short-range communications system. Examples of this process will be presented below.

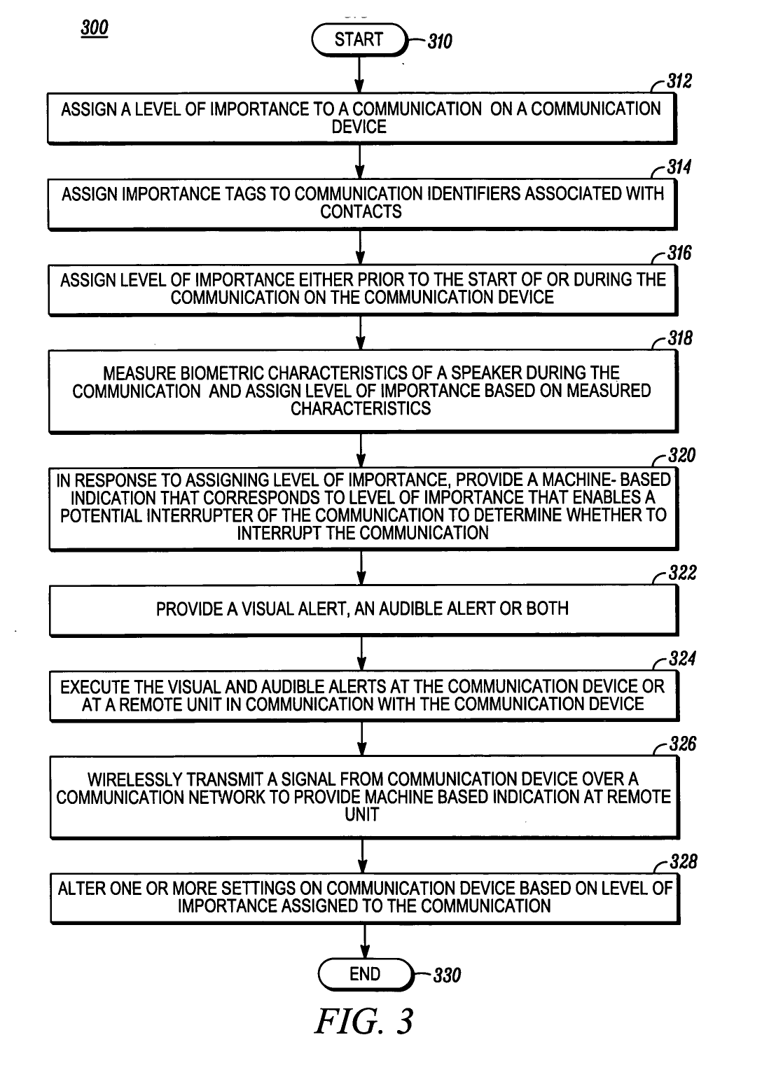

Referring to FIG. 3, a method 300 for the identification of the importance of a communication is shown. When describing the method 300, reference will be made to FIGS. 1 and 2, although it must be noted that the method 300 can be practiced in any other suitable system or device. Moreover, the steps of the method 300 are not limited to the particular order in which they are presented in FIG. 3. The inventive method can also have a greater number of steps or a fewer number of steps than those shown in FIG. 3.

At step 310, the method 300 can begin. At step 312, a level of importance can be assigned to a communication on a communication device. As an example, importance tags can be assigned to communication identifiers associated with contacts, as shown at step 314. Additionally, the level of importance can be assigned either prior to the start of or during the communication on the communication device, as shown at step 316. As an option, at step 318, one or more biometric characteristics of a speaker can be measured during the communication, and the level of importance can be assigned based on the measured characteristics.

For example, referring to FIGS. 1 and 2, a user or some other entity or component may assign a level of importance to a communication on the communication device 100. In particular, a user may assign importance levels or tags to communication identifiers associated with contacts in a contact list of a phonebook of the communication device 100. An importance level can be any designation that assigns a rating or some other measurable criteria that indicates how important a communication with a contact may be.

For example, a user may assign to the contacts in the phonebook one of three importance levels: (1) a red level for very important contacts or calls, where the user does not wish to be interrupted at all or only for narrow exceptions during the communication with the contact; (2) a yellow level for important contacts or calls, where the user may allow for more interruptions during the communication, as compared to the red level; and (3) a green level for relatively unimportant calls or contacts, where the user may freely allow for interruptions during a communication with this contact.

A contact can be any entity that the user may contact or that may contact the user. Although these contacts may typically be humans, a contact may also be a machine, such as an automated system that may wish to contact the user of the communication device 100. As a specific example, a user may program his supervisor's work number into his phonebook of his communication device 100, and the user may assign a red level of importance to this particular number. As such, when the supervisor calls the user on the user's communication device 100, the processor 110 may assign a red level of importance to this communication.

As an alternative, the user may assign a level of importance to the communication based on the user's desire. The user may do so by navigating through any suitable menu or some other user interface. Thus, the assignment of the level of importance may occur either prior to the start of or during the communication on the communication device 100. Also, other criteria may be considered when assigning levels of importance, such as the time of day when the communication is occurring. Further, the assignment of the level of importance can change as the communication continues, depending on the circumstances of the communication. This change can include an increase or a decrease in the level of importance. As such, the assignment of the level of importance can be dynamic in nature.

As another alternative, the biometric characteristic module 122 can assist in assigning the level of importance to a communication. For example, the biometric characteristic module 122 can detect signs of stress in a person's voice, including both the user of the communication device 100 and a caller calling the communication device 100. If the detected stress levels are high enough, the biometric characteristic module 122 can signal the processor 110, and the processor 110 can assign an appropriate importance level to the communication. For example, for a high detected stress level, a red level of importance or some other importance designation can be assigned to the communication. Other examples of characteristics of the user or the caller that can be measured can include heart rate, blood pressure, galvanic skin response or temperature.

Although three levels of importance have been described here, it is important to note that the invention is not so limited. Those of skill in the art will appreciate that there are other suitable ways to designate and assign levels of importance to various contacts that may be involved in a communication with the user of the device 100.

Referring back to the method 300 of FIG. 3, at step 320, in response to assigning the level of importance, a machine-based indication can be provided in which the indication can correspond to the level of importance. This machine-based indication can enable a potential interrupter of the communication to determine whether to interrupt the communication. At step 322, for example, a visual alert, an audible alert or both can be provided. At step 324, the visual and audible alerts can be executed at the communication device or at a remote unit in communication with the communication device. As another example, a signal can be wirelessly transmitted from the communication device over a communications network to provide the machine-based indication at the remote unit, as shown at step 326. In addition, one or more settings on the communication device can be altered based on the level of importance assigned to the communication, as shown at step 328. At step 330, the method 300 can end.

For example, referring once again to FIGS. 1 and 2, in response to assigning the level of importance, the processor 110 can generate a machine-based indication signal that corresponds to the level of importance. This signal can cause a visual alert, an audible alert or both to be executed at the communication device 100 or one or more of the remote units 200. In particular, the processor 110 can signal the light source 116 or the display 114 to illuminate in one of a plurality of colors that correspond to the different levels of importance.

As an example, if a red level of importance has been assigned in accordance with the discussion above, the processor 110 can signal the light source 116 and/or the display to illuminate in a red or reddish color. This principle can apply to the other settings described above or any other level of importance that may be used with the invention. As another example, the processor 110 can signal the speaker of the communication device 100 to broadcast an audible indication of the level of importance. As such, once the communication has been assigned with a level of importance, potential interrupters may see the visual alert or hear the audible alert. These alerts can help the potential interrupters determine whether to interrupt the communication of the user of the device 100. For purposes of the invention, a potential interrupter can be any entity, including both humans and machines, that may wish or need to contact the user of the communication device 100 while the user is involved in a communication on the device 100.

As noted above, the visual or audible alerts can be executed at one or more remote units 200, and these alerts may also correspond to the level of importance that has been assigned to the communication on the device 100. In particular, once the level of importance is assigned, the communication device 100 can signal one or more of the remote units 200. For example, the device 100, through its transceiver 112, can signal the wireless telephone or PDA 210, and the telephone or PDA 210 can take an appropriate action. These actions can include a visual or audible alert at the telephone or PDA 210, such as a message being displayed on a display or an audible message being broadcast on a speaker of the telephone or PDA 210. A similar process can occur for the computer 212. It is also understood that the alert may be in a form that enables a machine to determine whether to interrupt the communication at the device 100.

In either arrangement, potential interrupters can be made aware of the level of importance of the communication on the device 100, which can help the potential interrupter to decide whether it is appropriate to disturb the user of the device 100 involved in the communication. Although described in terms of wireless transmission, it is understood that the communication device 100 can signal the remote units 200 via a hard-wired connection, through its interface 120. Also, for wireless transmission, any suitable transmission standard or protocol can be employed here.

In another arrangement, the communication device 100 can signal (wireless or wired) the display 214. As an example, this display 214 can be positioned outside or near a work space or office of the user of the device 100 and can provide a visual and/or audible alert that corresponds to the assigned level of importance. The display 214, as an added, optional feature, can display the user's name. In yet another arrangement, the communication device 100, once the level of importance has been assigned, can signal the communications network 216. The communications network 216 can be, for example, a WAN, a WLAN or an NFC system. This way, the device 100 can signal one or more remote units 200 through the communications network 216.

In response to assigning the level of importance, one or more settings on the communication device 100 can be altered, based on the level of importance. For example, for a red or highest level of importance, the processor 110 can instruct the appropriate components in the device 100 to no longer accept incoming calls or text messages. Reminder alarms, such as those associated with a calendar function, can be silenced, too. As the importance level increases or decreases for a particular communication, the number of and type of settings that are altered can correspondingly change. For example, if the level of importance for a communication drops to a yellow or green level, the processor 110 can take action to allow incoming calls or messages to be received. It is understood that the invention is not limited to these particular examples, as any suitable setting of the device 100 can be altered in response to the assignment of the level of importance. In addition, if desired, the settings of one or more remote units 200 can be altered in a similar fashion.

Where applicable, the present invention can be realized in hardware, software or a combination of hardware and software. Any kind of computer system or other apparatus adapted for carrying out the methods described herein are suitable. A typical combination of hardware and software can be a mobile communications device with a computer program that, when being loaded and executed, can control the mobile communications device such that it carries out the methods described herein. Portions of the present invention may also be embedded in a computer program product, which comprises all the features enabling the implementation of the methods described herein and which when loaded in a computer system, is able to carry out these methods.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A method for identification of the importance of a communication, comprising:
assigning a level of importance to a communication on a communication device;
in response to assigning the level of importance, providing a machine-based indication that corresponds to the level of importance that enables a potential interrupter of the communication to determine whether to interrupt the communication.

2. The method according to claim 1, wherein assigning the level of importance comprises assigning importance tags to communication identifiers associated with contacts.

3. The method according to claim 1, wherein assigning the level of importance comprises assigning the level of importance either prior to the start of or during the communication on the communication device.

4. The method according to claim 1, further comprising measuring one or more biometric characteristics of a speaker during the communication and assigning the level of importance comprises assigning the level of importance based on the measured characteristics.

5. The method according to claim 1, wherein providing a machine-based indication comprises providing a visual alert, an audible alert or both.

6. The method according to claim 5, wherein providing a machine-based indication further comprises executing the visual and audible alerts at the communication device or at a remote unit that is in communication with the communication device.

7. The method according to claim 6, further comprising wirelessly transmitting a signal from the communication device over a communications network to provide the machine-based indication at the remote unit.

8. The method according to claim 6, wherein the remote unit is a telephone, a personal digital assistant, a computer or a display.

9. The method according to claim 1, further comprising altering one or more settings on the communication device based on the level of importance assigned to the communication.

10. The method according to claim 5, wherein the visual alert is from a light source illuminated in one of a plurality of colors that correspond to different levels of importance.

11. A communication device that identifies the importance of a communication, comprising:
a transceiver that receives and transmits communication signals; and
a processor coupled to the transceiver, wherein the processor is programmed to:
assign a level of importance to a communication on a communication device; and
in response to assigning the level of importance, generate a machine-based indication signal that corresponds to the level of importance that enables a potential interrupter of the communication to determine whether to interrupt the communication.

12. The communication device according to claim 11, wherein the processor is further programmed to assign importance tags to communication identifiers associated with contacts.

13. The communication device according to claim 11, wherein the processor is further programmed to assign the level of importance either prior to the start of or during the communication on the communication device.

14. The communication device according to claim 11, further comprising a biometric characteristic module that measures one or more biometric characteristics of a speaker during the communication and signals the processor, wherein the processor is further programmed to assign the level of importance based on the measured biometric characteristics of the speaker.

15. The communication device according to claim 11, further comprising a light source, a speaker or both.

16. The communication device according to claim 15, wherein the machine-based indication signal selectively illuminates the light source or selectively broadcasts audio from the speaker.

17. The communication device according to claim 16, wherein the machine-based signal selectively illuminates the light source in one of a plurality of colors that correspond to different levels of importance.

18. The communication device according to claim 11, wherein the transceiver transmits the machine-based indication signal to a remote unit that is in communication with the communication device.

19. The communication device according to claim 18, wherein the remote unit is a telephone, a personal digital assistant, a computer or a display.

20. The communication device according to claim 11, wherein the processor is further programmed to alter one or more settings on the communication device based on the level of importance assigned to the communication.

21. A machine readable storage, having stored thereon a computer program having a plurality of code sections executable by a computing device for causing the computing device to perform the steps of:
assigning a level of importance to a communication on a communication device; and
in response to assigning the level of importance, providing a machine-based indication that corresponds to the level of importance that enables a potential interrupter of the communication to determine whether to interrupt the communication.

22. The machine readable storage according to claim 21, wherein the code sections further cause the computing device to execute visual or audible alerts at the computing device or at a remote unit that is in communication with the computing device.
